(19) United States
(12) Patent Application Publication
(10) Pub. No.: US 2015/0100182 A1
(43) Pub. Date: Apr. 9, 2015

(54) METHOD FOR FIGHTER TAKEOFF AND LANDING WITHIN ULTRA-SHORT DISTANCE (ULTRA-STOL)

(71) Applicant: Shouqin Zhu, Pomona, CA (US)

(72) Inventor: Shouqin Zhu, Pomona, CA (US)

(21) Appl. No.: 14/046,717

(22) Filed: Oct. 4, 2013

(51) Int. Cl. B64F 1/00; B64C 19/00; B64F 1/16

(52) U.S. Cl. CPC B64F 1/00; B64F 1/16; B64C 19/00
USPC 701/3; 244/63; 244/114 R; 244/110 R

(57) ABSTRACT

A method for a fix-wing fighter to take off and land on an ultra-short distance is disclosed. In one embodiment, a method for a fighter to take off with an ultra-short distance may include providing a runway on a predetermined height, wherein the runway is shorter than a normal runway; disposing the fighter at said runway; and providing the fighter with an initial speed and the fighter is able to accelerate on said runway; wherein the fighter reaches its takeoff speed (which is smaller than a normal takeoff speed of the fighter) at the end of the runway, and is then accelerated by a combination of the flighter's acceleration and gravitational acceleration until the fighter reaches its normal takeoff speed.

### FIELD OF THE INVENTION

The present invention relates to a method for a fixed-wing fighter to take off and land, and more particularly a method for a land-based and fixed-wing fighter to take off and land within an ultra-short distance.

### BACKGROUND OF THE INVENTION

Reducing the running distance for takeoff and landing of a fighter and reliance of the runway that can be easily damaged, and minimizing the cost of runway construction and the negative impact of excessive resource allocation of fighter takeoff and landing are the long-term goals and global difficulties for military and fighter designers. Long runways can only be built in limited areas and for economic concerns, there are not many airports with long runways, which limits the activity range of fighters. Especially if these vulnerable long runways were attacked and damaged during wartime, the fighters would be stranded on the ground and destroyed. One striking example is that in the third Arab-Israeli War, on June 5 of 1967, Israeli air force raided and paralyzed the Arabic air bases and destroyed several hundreds of the then most advanced Soviet-made MiG-21 on the ground. Generally speaking, the power of the air force is a combined result of the four major subsystems including an information group (Intelligence), a command group, a fight group (fighters), and a support group (mostly for airbases and runways), and its operational capacity is determined by the integration of these subsystems. Inefficiency in any one of these subsystems can lead to the failure of the entire air force. Therefore, the power of the air force resembles a bucket assembled with four wood boards, and the capacity of the bucket is limited by the shortest board. Although significant progress has been made in other subsystems, the shortcomings in the support subsystem, more specifically the runway, will ultimately affect the operation of air force as the obvious “short board”. Although the world's military and the aviation industry have made unremitting efforts to solve this bottleneck problem, so far there has no any satisfactory result.

Existing approaches to solve this “short board” runway problem are unsatisfactory. The means of aerodynamic design, including the planar shape of the wing, airfoil profile, use of flaps (including jet flap) and the drag parachute, etc. have shown to be not remarkably useful, as the running distance remains very long, in particular the landing distance.

For fixed-wing vertical takeoff and landing fighters, such as the British Harrier Jump Jet, the former Soviet Yak-38 and Yak-141, and the United States V-22 Osprey, F-35B, etc., rely on the airborne system to generate an aerodynamic lift. Although these fighters do not depend on airport runways, their common feature of bulky, expensive lift-generating power system which functions only during the takeoff and landing phases significantly limits their performance and capacity. For example, the bulky and expensive lift-generating power system reduces the loading capacity of fuel and weapons, and weakens their performance in fight missions. Moreover, this system negatively affects these fighters' supersonic performance. For example, the Harrier Jump Jet and the Yak-38 do not support supersonic performance, and F-35B allows only a slightly higher speed above supersonic (M1.4). In addition, the V-22 Osprey, which simply relies on propeller and rotary wing to generate the lifting power, has a very low speed and cannot be categorized as a fighter. Also, these fighters are expensive and developed slowly, for instance, in order to meet the requirements of vertical takeoff and landing, progress of the F-35B development was significantly delayed with dramatically increased budget, resulting in the cost of more than 100 million US dollars for one F-35B.

Although the world's military and the aviation industry have made unremitting efforts to solve this bottleneck problem, so far there has no any satisfactory result. The fact that these means failed to generate a satisfactory result can be attributed to several key reasons. First, for a fighter to take off from the ground, it must accelerate to a threshold speed when the fighter is subjected to a lift greater than its own weight. Similarly, for a fighter to land, the speed of the fighter has to be reduced to a certain level, namely the landing speed, when the lift is equal to its own weight. So far, the long running distance for the fighter to take off and land cannot be shortened because these threshold speeds cannot effectively reduced. In other words, the fighter needs a long running distance for landing and takeoff.

Secondly, both military and fighter designers are inappropriately relying on the fighter design department to solve the problem of long runway. They attempt to reduce the running distance for takeoff and landing solely by changing the fighter design, and are not open for other solutions. Thus, there remains a new and improved method to overcome the problems presented above.

### SUMMARY OF THE INVENTION

It is an object of the present invention to provide means for fighters to take off at less than normal takeoff speed, under the same condition of its own weight and external carriage loads.

It is another object of the present invention to provide means for fighters to land at less than the normal landing speed, under the same condition of its own weight and external carriage loads.

It is a further object of the present inventions to provide a tilted runway (at an angle of not less than 10 degrees) landing technique. This technique resolves the aforementioned key problems that lead to long running distances. By improving both the runway and the fighter, this technique reduces the takeoff and landing speed to allow the reduction in running distances. For the positive effect, this technique expands the potential of fighters without compromising the capacity for completing major missions and main performance features.

In one embodiment, the geometric relationship between the fighter and runway (e.g. height difference—using gravitational acceleration and deceleration) is used to reduce the takeoff and landing speed to achieve ultra short take off and landing (ultra-STOL). With the height difference, the fighter can accelerate and decelerate in the air to reach the normal takeoff and landing speed. In another embodiment, fighters can be landed on a tilted, specially-designed runway.

Using the method in the present invention, the landing distance of F-16A and MiG-21 can be reduced by 50% or more in comparison with the normal landing distance according to publicly available information. Similarly, the (takeoff) running distance is reduced by a similar degree. With the tilted runway in the present invention, F-16A may land within 150-200 meters. In particular, it can be more effective in reducing takeoff and landing distances for fighters equipped with vector thrust engines.

When the takeoff and landing distances are reduced, the length of an airport runway can be significantly shortened, allowing more airports and therefore more air force bases built under the same conditions and with same budget. The air force power can be extended to a much wider region, thereby significantly improving the capability of air missions.

Furthermore, the defense of the airport system, the air force and the overall viability of the protected targets during wartime are improved. During the wartime, more available airports indicate more targets for being attacked. In the case that a certain number of enemy assaulting weapons including fighters are dispatched, each airport provides the enemy a clear target to attack to further paralyze the air force on the other side. With the technique disclosed in the present invention, the costs to build the airport can be significantly reduced, and the number of airport can be increased. So, there become more targets to attack for the enemy's air force, which weakens the enemy's air attacking power.

The tilted runway has a dramatically increased viability. Even the runway was hit by bombs or missiles, it is unlikely to be totally destroyed the runway because of its geometric shape.

The present invention provides new opportunities and directions for optimizing national defense structure within a fixed budget. For example, with this technique, airports with short runways may be built on islands in the oceans or in high altitude areas. These airports require limited personnel for maintenance during peacetime, and can be used as stations for fighter fleets during wartime, and when necessary, a huge number of fighters can be gathered thereon. Comparing with aircraft carriers, the cost is obviously much lower than dispatching special mixed fleets. For optimizing the structure of force, the same missions can be accomplished, and the same fighting capability can be achieved with lowest cost. It is obvious that building multiple airports with ultra-short runways would be significantly more economic than having a number of task force fleets. Therefore, this ultra-STOL technology provides a new possible choice.

### BRIEF DESCRIPTION OF THE DRAWINGS

FIG. 1 illustrates one embodiment of fighters using ultra short running distance to take off in the present invention.

FIG. 2 illustrates another embodiment of fighters using ultra short distance for landing in the present invention.

FIG. 3 illustrates a further embodiment of fighters using the tilted runway for landing in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

The present invention provides an evolutionary change to the existing takeoff and landing technology of land-based fixed-wing fighters Implementation of this technique should start with one specific type of fighters and then extend to other major types. Performance characteristics of the target fighters must be fully studied.

Firstly, the fighter's status, capability and limitation should be studied, and the implementation of this technology should be proven technically feasible by ultra-STOL theoretical model analysis.

Secondly, the fighter types and their specific characteristics should be subjected to theoretical calculations to optimize their operation parameters for the desired ultra-STOL performance

Thirdly, through the use of a ground simulator, with the involvement of a few experienced pilots with experience in flying multiple types of fighters under various flight environments, a real-time simulating process of takeoff and landing using this ultra-STOL technique with multiple types of fighters has to be conducted. So, the sensitivity and accuracy of the pilots' responses during the simulation can be studied and the ultra-STOL technique can be improved. In addition, the simulation can also test the technical feasibility of the ultra-STOL technique. When necessary, the information of fighter performance characteristics (such as the autopilot system responsible for landing and corresponding fighter design parameters) may be required. Also, ground guidance, command and control equipment (with corresponding functional requirements and design parameters) and ground control personnel (number and division of functions) may be necessary to satisfy the need for the ultra-STOL. In addition, in the simulating process, conditions that may be encountered in actual STOL operations, such as various weather conditions, night condition, gust wind, crosswind, temperature, simultaneous takeoff or landing of multiple batches and different types of fighters, and possible terrain conditions, can be incorporated so it would be much closer to real situations. Since the simulating process is inexpensive and risk free, and acts as a partial alternative of the actual flight test, it can be a critical tool for testing the ultra-STOL technique as well as an essential step prior to actual flight test.

The method for verifying the effect of the tilted runway for fighter landing should start with a theoretical analysis, then test the results of the theoretical analysis with a ground simulator, and propose detailed instruction on how to implement the actual flight test of that specific type of fighters.

In order to implement this ultra-STOL technique, it is necessary to establish the associated ground guidance, command, control systems, as well as the corresponding computer and software systems. The systems should be tested by ground simulators to determine the design parameters. It should particularly be noted that, since the time for takeoff or landing using the ultra-STOL technique is extremely short, especially for landing, it might be difficult for the pilots to respond accurately and in a timely manner Therefore, the ground guidance, command and control system, as well as their computer and software system, and onboard equipment corresponding to ground systems, including an onboard autopilot system, would be the key for the implementation of this ultra-STOL technique. In the future, to test the effect of applying this ultra-STOL technique with a vector thrust engine equipped fighter, the test should also start with the appropriate theoretical analysis, and then the simulation stage with a ground simulator.

Based on the aforementioned, this technology should first be tested with certain types of the existing fighters and with suitable regular runways in certain existing airports, which are close and stretch to cliffs and can then be further extended to other types of fighters upon successful initial tests. On the basis of successful tests with regular runways in the existing airports, this technique will be further tested with newly constructed on tilted runways. Furthermore, the economic analysis of this ultra-STOL technology will be conducted, and compared with that of a conventional runway.

In addition to the analyses and tests, the existing and possible future airports that are suitable for this ultra-STOL technology, especially the construction on islands or on high altitude areas, need to determined. The corresponding effects, including the tactical and strategic effect as well as the economic impact should also be considered. The effect of using the ultra-short-runway airports on the distribution of air force power, as well as on the optimization of the force structure should also be assessed.

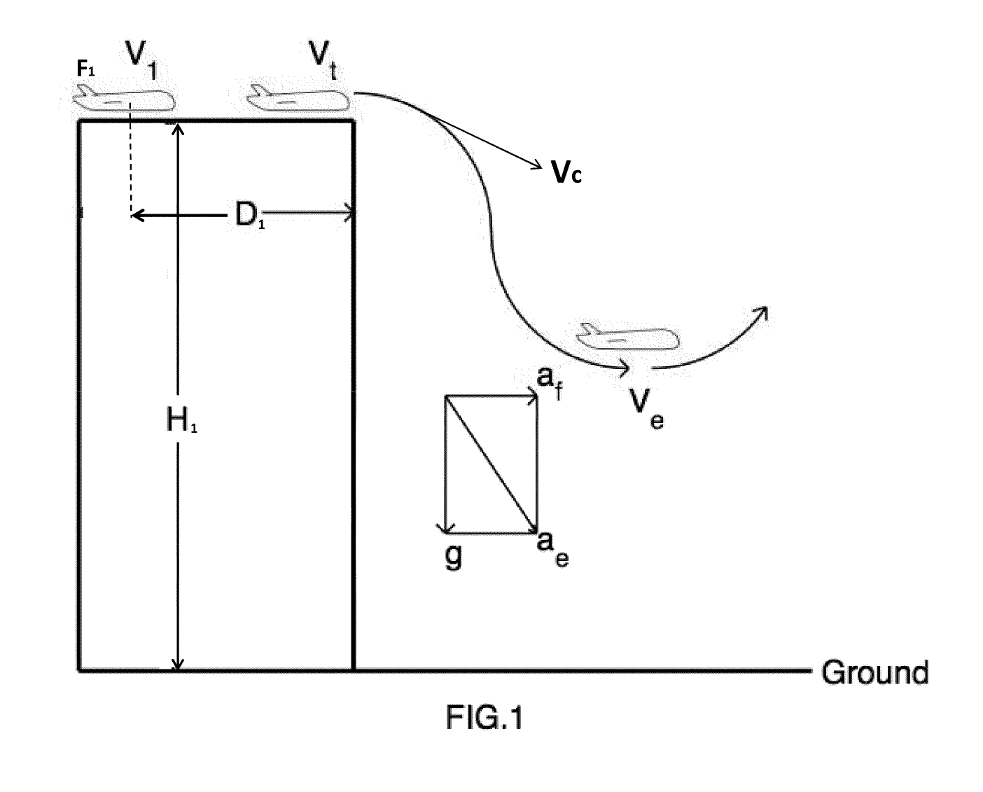

Referring to FIG. 1, a fighter F₁ is disposed on a flat surface with a height H₁, and distance of a runway for the fighter F₁ is D₁, which is substantially shorted than a regular takeoff runway for the fighter F₁. The fighter F₁ starts with an initial speed V₁ (preferably equals to zero) and a takeoff speed V₁ at the end of the runway, and when the fighter F₁ leaves the runway, the fighter F₁ may firstly go down along the direction of aₑ because of gravitational acceleration (g) and the fighter F₁'s accerleration a_{f}, and the fighter F₁ can be accelerated by the acceleration aₑ until the fighter F₁ reaches its normal takeoff speed Vₑ. Under such circumstances, the fighter uses a shorter runway D₁ with a smaller takeoff speed Vₜ, and the normal takeoff speed Vₑ can be obtained through the assistance of gravitational acceleration. In one embodiment, D₁ can be about fifty percent (50%) shorter than a normal runway. It is noted that when the fighter F₁ takes off, it may encounter a lifting force, a drag, gravity and thrust, and the acceleration aₑ results from the combination of the abovementioned force. Also, as can be seen in FIG. 1, the direction of the speed V_{c} when the fighter just takes off is different from the acceleration aₑ.

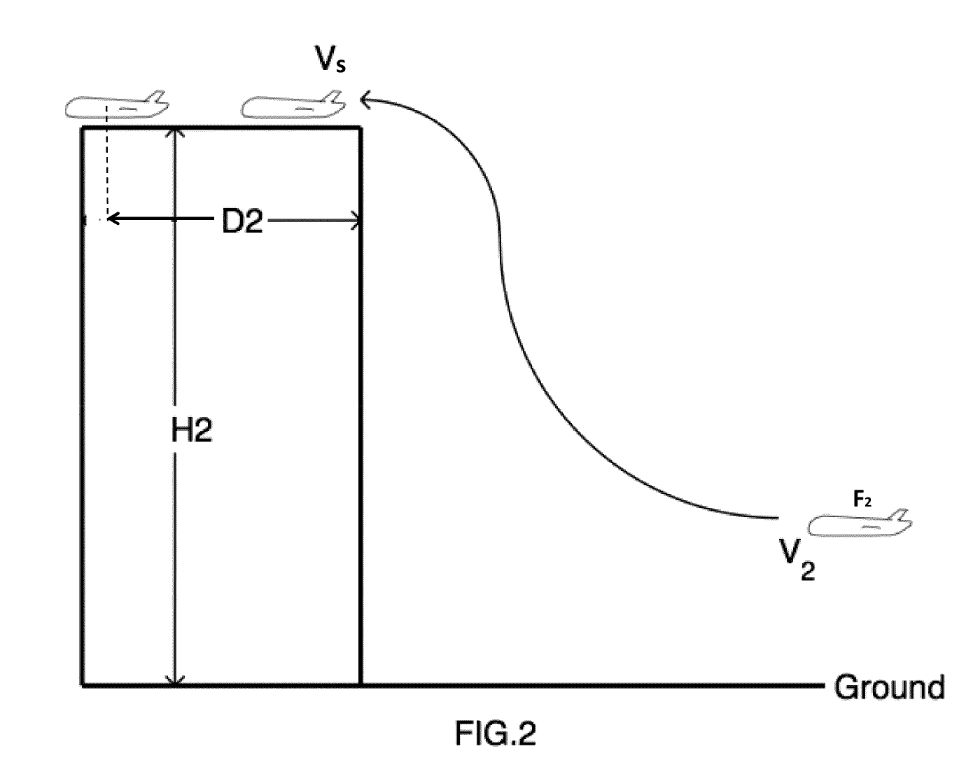

Referring to FIG. 2, a fighter F₂ with an initial speed V₂ tries to land on a shorter landing distance D₂ on a flat surface with a height H₂. The initially speed V₂ can be gradually reduced because the fighter F₂ is climbing to a higher landing surface against the gravitational force, and the fighter F₂ can be landed with the shorter landing distance D₂ It is noted that a landing speed Vₛ can be calculated according to the height H₂ and the initial speed V₂ of the fighter F₂, and the landing speed Vₛ and fighter F₂'s flight path should be tangent to the landing surface when climbing thereto.

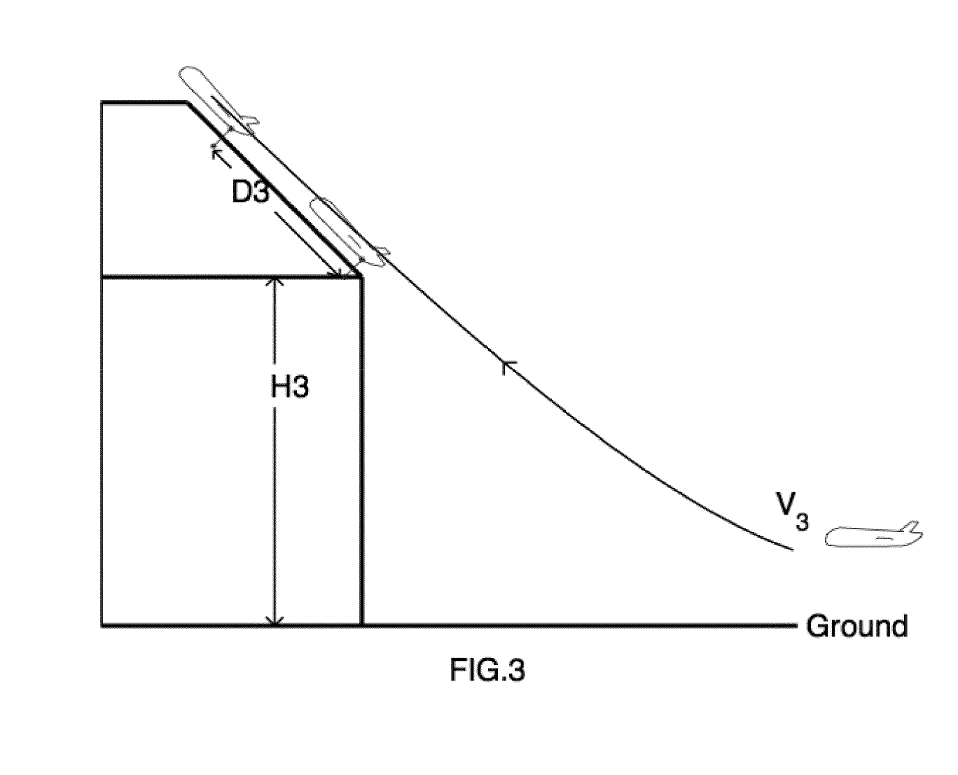

Referring to FIG. 3, a fighter F₃ with an initial speed V₃ tries to land on a shorter landing distance D₃ on a tilted runway above a height H₃. The fighter F₃ would start climbing to the height H₃ and then try to land on the tilted runway against the gravitational force. It is noted that D₃ can be much shorter than conventional landing distance, and can be even shorter than D₂ in FIG. 2 because the fighter is travelling against the gravitational force on the tilted runway. Also, on the titled runway, a plurality of stopping blocks are configured to pop out to prevent the fighters from falling down from the runway, and when the fighter F₃ is fully stopped, the unused stopping blocks can be restored to their original positions. In one embodiment, the angle θ is larger than 10 degrees. Furthermore, when this tilted runway is attacked, it is unlikely to be damaged due to its special geometrical shape. The fighter landed on the tilted runway would be transported to a facility so that the runway can be used for subsequent fighters for landing, and the landed fighters can be maintained and prepared for next flight.

Having described the invention by the description and illustrations above, it should be understood that these are exemplary of the invention and are not to be considered as limiting. Accordingly, the invention is not to be considered as limited by the foregoing description, but includes any equivalents.

1. A method for a fighter to take off with an ultra-short distance comprising:
providing a runway on a predetermined height, wherein the runway is shorter than a normal runway;
disposing the fighter at said runway; and
providing the fighter with an initial speed and the fighter is able to accelerate on said runway;
establishing ground guidance, command and control systems, as well as computer and software systems thereof, and onboard equipment corresponding to ground systems, including an onboard autopilot system;
wherein the fighter reaches its takeoff speed (which is smaller than a normal takeoff speed of the fighter) at the end of the runway, and the fighter drops toward the ground without the runway for a predetermined distance with an acceleration that is a combination of the fighter's acceleration and gravitational acceleration until the fighter reaches its normal takeoff speed.

2. A method for a fighter to land with an ultra-short distance comprising:
providing a runway on a predetermined height, wherein the runway is shorter than a normal runway; and
providing a fighter with an initial speed;
establishing ground guidance, command and control systems, as well as computer and software systems thereof, and onboard equipment corresponding to ground systems, including an onboard autopilot system;
wherein the fighter climbs without the runway for a predetermined height against the gravitational force, and the initial speed of the fighter gradually reduces to enable the fighter to land on the runway located on said predetermined height.

3. The method for a fighter to land with an ultra-short distance on claim 2, wherein a landing speed is obtained according to the predetermined height of the runway and the initial speed of the fighter.

4. The method for a fighter to land with an ultra-short distance on claim 3, wherein the landing speed is tangent to the runway when the fighter is prepared to land on the runway.

5. A method for a fighter to land with an ultra-short distance comprising:
providing a tilted runway on a predetermined height;
providing a fighter with an initial speed;
wherein the fighter climbs to the tilted runway on a predetermined height against the gravitational force, and the initial speed of the fighter gradually reduces to enable the fighter to land on the tilted runway.

6. The method for a fighter to land with an ultra-short distance on claim 5, wherein a landing speed is obtained according to the predetermined height of the tilted runway, angle of the tilted runway, and the initial speed of the fighter.

7. The method for a fighter to land with an ultra-short distance on claim 5, wherein a plurality of stopping blocks are configured to pop out to prevent the fighters from falling down from the runway, and when the fighter is fully stopped, the unused stopping blocks can be restored to their original positions.

8. (canceled)

9. (canceled)

10. The method for a fighter to take off with an ultra-short distance of claim 5, further comprising a step of establishing ground guidance, command and control systems, as well as their computer and software systems, and onboard equipment corresponding to ground systems, including an onboard autopilot system.
